(19) United States
(12) Patent Application Publication
(10) Pub. No.: US 2009/0223434 A1
(43) Pub. Date: Sep. 10, 2009

(54) LIMIT LIGHTS

(75) Inventor: Thomas Alan Zorn, Syracuse, NY (US)

Correspondence Address: BOND, SCHOENECK & KING, PLLC, ONE LINCOLN CENTER, SYRACUSE, NY, 13202-1355, US

(73) Assignee: J. R. CLANCY, INC., Syracuse, NY (US)

(21) Appl. No.: 12/400,339

(22) Filed: Mar. 9, 2009

Related U.S. Application Data
(60) Provisional application No. 61/034,568, filed on Mar. 7, 2008.

(51) Int. Cl. B66B 3/02

(52) U.S. Cl. 116/226

(57) ABSTRACT

A lift system including a visual indicator device (for example, an LED indicator light) in data communication with travel limit switches so that tripping of the travel limit switches (or at least the travel limit switches that are manually set by a human assembler) will cause the visual indictor device to make a visual indication that can be readily observed by the human assembler. The visual indication of the present indication can helpfully replace the conventional method of listening for a click during the step of setting the location of the travel limit switch when the lift system is initially set up by a human assembler. Instead of listening for a click, the assembler can watch for a visual indication by the visual indicator device, such as the lighting of an LED. this can make the assembler's job easier and can facilitate quicker and more reliable setting of the location of travel limit switches in the lift system. Also, the correspondence between travel limit switches and indicator lights makes it much less likely that the installer will miswire the indicator lights.

### RELATED APPLICATION

The present application claims priority to U.S. provisional patent application No. 61/034,568, filed on Mar. 7, 2008; all of the foregoing patent-related document(s) are hereby incorporated by reference herein in their respective entirety(ies).

### BACKGROUND OF THE INVENTION

1. Field of the Invention

The present invention relates to lift systems (see DEFINITIONS section) and more particularly to lift systems for theatrical applications.

2. Description of the Related Art

Indicator lights are known. One example of this is U.S. Pat. No. 4,750,294 (“Lafontaine”) which discloses a power operated door that includes: (i) a limit switch that is tripped to enable field adjustment of a safety mechanism; and (ii) an indicator light indicating when the limit switch is activated. Lafontaine does not disclose or otherwise contemplate any sort of lift system.

Lift systems having indicator light(s) to indicate certain conditions are known. One example of this is U.S. Pat. No. 7,243,870 (“Pook”) which discloses a portable studio hoist system including a remote pendant including a power indicator light.

Lift systems having travel limit switches are known. Publications that may show travel limit switches include: (i) US patent application (“USPA”) 2004/0238804 (“Revi”); (ii) U.S. Pat. No. 5,361,565 (“Bayer”); U.S. Pat. No. 6,520,485 (“Soot”); (iii) U.S. Pat. No. 7,410150 (“Falls”); (iv) U.S. Pat. No. 5,458,537 (“Crider”); and (v) U.S. Pat. No. 4,793,439 (“Crawford”).

FIG. 1 shows a conventional lift system 100 having travel limit switches. Lift system 100 includes: lift hardware 102; lift controls 104; striker member 106; primary lower travel limit switch 108; primary lower travel limit switch 109; primary upper travel limit switch 110; secondary upper travel limit switch 111; load 120; loft blocking sub-system 122; and cable 124. Installer 101 installs lift system 100, typically in a theatre. For example, load 120 may be a batten that should only be allowed to travel in direction D1 between upper travel limit U and lower travel limit L in order to prevent physical interference with other objects such as rafters, floors, people, etc.

Lift hardware 102 includes a rotating drum around which cable 124 is would and unwound to raise and lower load 120. Lift hardware may include other hardware such as a motor to rotate the drum, a gear train, a brake, a head block sub-system and any other lift related hardware. The lift controls 104 may be as simple as a hand crank (for a manually powered lift). Alternatively, the lift controls may be manual controls for controlling lift motion in the context of a powered lift with a motor. Alternatively, the lift controls may include automatic software and/or hardware control and/or remote control using machine readable instructions (for example, lift motion control over a computer network).

During normal operations of the lift striker member 106 moves back and forth along direction D2 as the cable is wound and unwound, thereby raising and lowering the load in direction D1. For example, in lifts where the drum translates along the direction of its central axis to maintain a constant fleet angle, the striker member may be constrained to translate with the linear translation on the drum. As another example, in lifts where a head block sub-system translates linearly to maintain a constant fleet angle, the striker member may be constrained to translate with the linear translation on the drum. Still other ways of moving the striker member are possible. For example, it may be possible to have a rotating striker member whose rotation is correlated with rotation of the drum and/or rotation of a head block pulley or roller. The exact mechanism for moving the striker member and/or the particular motion vectors of the striker member are not important for present purposes. The important thing about the striker member is that it moves in a way that is correlated with the motion of the load.

During normal operations of the lift system, the lift motion should be controlled so that the striker member remains between primary lower travel limit switch 108 and primary upper travel limit switch 110. The position of primary lower travel limit switch 108 correlates to a load position where the bottom of the load is at lower travel limit L. The position of primary upper travel limit switch 110 correlates to a load position where the top of the load is at upper travel limit U. By maintaining the striker member in between switches 108 and 110 as it moves back and forth in direction D2, it can be assured that load 120 remains in its safe travel range between limits U and L.

Sometimes a problem may arise so that the load is raised above upper limit U or lower limit L. To name some examples, there may be a mechanical problem with the lift hardware, an error by a person controlling manual control, or an error in the machine readable instructions performing automatic motion control. If the load is lowered below lower limit L then striker member 106 strikes switch 108 and the lift controls 104 take appropriate corrective action. Such appropriate corrective actions may include, but are not necessarily limited to: stopping all lift motion, raising the lift, sounding an alarm, sending out notification of the malfunction out to a master controller computer, turning on a lift brake, etc. For present purposes, the exact nature of the corrective action is not important. What is important is that the interaction of the striker member 106 and switch 108 effectively detects a problem and signals the existence of the problem to the lift controls 104. Similarly, the striker member 106 and switch 110 effectively detect that the load has been raised above its upper travel limit U and signal the existence of this kind of malfunction to the lift controls for appropriate corrective action.

Although in system 100 the switches are shown to be switches that operate by mechanical movement, other types of switches may be possible such as magnetically operated switches, electrically operated switches, optically operated switches, thermally operated switches, etc. Depending on the type of switch, physical contact between the striker member and the switch may not always be required to actuate the switch. The degree and kind of contact, proximity and/or alignment required for a striker member to operate a particular kind of switch will generically be referred to herein as an “switch-tripping connection.” Although in system 100 the switches are stationary and the striker member moves in a manner correlated to the motion of the load, it is probably possible to design a lift system where: (i) the limit switch(es) move along direction D2 in a manner correlated with the motion of the load in direction D1; (ii) the striker is in the form of a striker assembly having a stationary striker member for the lower limit and another stationary striker member for the upper member; and (iii) the moving limit switch(es) is/are tripped when the motion in direction them D2 causes them to establish a switch-tripping connection with one of the striker members.

As shown in FIG. 1, secondary lower travel limit switch 109 and secondary upper travel limit switch 111 are placed outside of their respective primary switches in the direction D2. Secondary lower travel limit switch 109 and secondary upper travel limit switch 111 are a sort of fail safe mechanism in case: (i) the primary switches malfunction; or (ii) the corrective action caused by the signaling provided by the primary switches is insufficient to stop the overtravel that is occurring. The corrective actions taken when the secondary switches are tripped may or may not be the same as the corrective action taken when the primary travel limit switches are tripped.

In order to use the travel limit switches 108, 109, 110, 111 of lift system, the system has to be set up first. Part of this set up is the physical location of the travel limit switches 108, 109, 110, 111. Generally speaking, these must be set into a relatively precise physical location along direction D2 for each installation. The location along D2 will depend primarily upon the location of the upper and lower limits U and D, but may also depend upon other factors like location of the lift hardware 102, location of the loft blocking assembly 122, the cable thickness and so on. For these reasons, travel limit switches are manually located in the D2 direction by a human assembler 101 for each installation (for example, each theatrical production).

The human assembler 101 sets the D2 direction location of the primary limit switches by the following steps: (i) placing the primary limit switches 108 and 110 at locations that are estimated to be correct; (ii) checking the placement of the primary switches 108, 110 by raising and lowering load 120 to the upper and lower limits U, L using lift hardware 102 and lift controls 104; (iii) adjusting the location of primary travel limit switches 108, 110 as necessary based on observations at step (ii); and (iv) repeating step (ii) and step (iii), as needed, until the primary travel limit switches are in correct locations along direction D2; (v) ensuring the precisely located travel limit switches are in the untripped position; and (vi) putting the precisely located primary travel limit switches into data communication with lift controls 104 so that the lift controls will take appropriate corrective action upon tripping of the primary travel limit switch. After the location of the primary limit switches are set, the secondary limit switches can be placed just a bit outside of the primaries in the D2 direction.

As stated above, step (ii) involves checking the placement of the primary switches by raising and lowering load. More specifically, the location of the load is visually observed by the assembler. However, the primary limit switches are generally not visually observable by the assembler while she is controlling and observing the lifting and lowering of the load, primarily because the location of the primary travel limit switches is visually obscured by the lift hardware 102 and/or lift controls 104. Moreover, even if a lift system is designed so that the primary travel limit switches were in a line of sight of the assembler, they would still be difficult to see due to small size and distance. Therefore, instead of trying to visually observe the relative locations of the striker member 106 and the primary limit switches 108, 110 at step (ii), the assembler instead listens for a click sound that occurs when a limit switch is tripped. This conventional method has long been thought to be a sufficient and optimal way to set travel limit switches, especially in theatrical lift applications.

Other prior art publications which may be of interest may include: (i) USPA 2005/0271469 (“Zebryk”); and (ii) USPA 2004/0099853 (“Verakis”).

Description Of the Related Art Section Disclaimer: To the extent that specific publications are discussed above in this Description of the Related Art Section, these discussions should not be taken as an admission that the discussed publications (for example, published patents) are prior art for patent law purposes. For example, some or all of the discussed publications may not be sufficiently early in time, may not reflect subject matter developed early enough in time and/or may not be sufficiently enabling so as to amount to prior art for patent law purposes. To the extent that specific publications are discussed above in this Description of the Related Art Section, they are all hereby incorporated by reference into this document in their respective entirety(ies).

### BRIEF SUMMARY OF THE INVENTION

The present inventions recognizes that there are potential problems and/or disadvantages in the above-discussed way of setting travel limit switches in lift systems and especially in theatrical lift systems. One potential problem is that the click sound used to check the location of the travel limit switch is soft in sound volume and difficult to hear, especially amidst the chaotic and high volume noise of the setup of a theatrical production or other construction site. A related potential problem is that other ambient noises can be mistaken for a click, causing the operator to (temporarily until investigating) think that a travel limit switch undergoing set up has been tripped when it has, in fact, not been tripped. Another problem is that some mechanical switches are subject to being broken and/or dislodged if the striker member pushes them too far. What this means is that if an assembler misses the click sound and, as a result, continues to move the load and correlated striker in anticipation of the missed click sound, then the switch and/or switch mounting hardware may break. Still another potential disadvantage is that listening for the click, in the din of a construction site, becomes something of a learned skill that requires experience and training. Also, it means that people with less than perfect hearing cannot set travel limit switches during lift system set up.

Another potential problem recognized by the present invention is that limit switches can be mixed up when they are set into position along the D2 direction. For example, the primary upper limit switch may be placed at the lower limit position and the primary lower limit switch may be placed to the upper limit position. This is a serious problem, especially when the corrective action taken by the lift controls upon striking the upper limit switch is different than the corrective action taken by the lift controls upon striking the lower limit switch.

Various embodiments of the present invention may be advantageous in that they may solve or reduce one or more of the potential problems and/or disadvantages discussed above in the previous two paragraphs. At least some embodiments of the present invention can make the assembler's job easier and can facilitate quicker and more reliable setting of the location of travel limit switches in the lift system, especially for noisy theatrical applications where it is difficult to hear the click of the travel limit switch being set into position. Also, miswiring problems can be more readily identified because the “wrong” light will light up if the travel limit switches have been mixed up. In some preferred embodiments of the present invention, different colored indicator lights are used for the different travel limit switches so that the color, as well as the position of the light, makes it clear to the installer which travel limit switch has been tripped at any given time during the installation process.

The present invention is directed to a lift system including a visual indicator device (for example, an LED indicator light) in data communication with the travel limit switches so that tripping of the travel limit switches (or at least the travel limit switches that are manually set by a human assembler) will cause the visual indictor device to make a visual indication that can be readily observed by the human assembler. The visual indication of the present indication can helpfully replace the conventional method of listening for the click. the present invention is further directed to a method of setting up a lift system including the use of a visual indication to help set the location of at least one of the travel limit switches.

According to one aspect of the present invention, a lift system for lifting and lowering a load includes lift hardware, a striker member, a first travel limit switch and a visual indicator device. The hardware is structured to raise and lower the load. The striker member is structured and/or mechanically connected to the lift hardware so that the striker member moves along a path in correlation with the lifting and lowering of the load. The first travel limit switch is in the form of mechanical switch. the first travel limit switch is located at least partially on the path. The first travel limit switch is structured so that it will trip when the striker member makes contact with it. The visual indicator device is in data communication with the first travel limit switch. The visual indicator device is structured and/or programmed to give a first visual indication when the first travel limit switch is tripped.

According to a further aspect of the present invention, a method of setting up a lift system, the method includes the following steps (not necessarily in the following order except as indicated): (a) installing a lift system sub-assembly, including lift hardware and a striker member, in or onto a structure; (b) connecting a load to the lift hardware; (c) approximately locating a travel limit switch at an approximate position; (d) putting the travel limit switch in data communication with a visual indication device; (e) subsequent to steps (d), (c), (b) and (a), moving the load, by the lift hardware, to a location in proximity to a desired travel limit for the load; (f) during step (e), observing, by a human operator, a visual indication, by the visual indication device, corresponding to the tripping of the travel limit switch; and (g) during steps (e) and/or (f), stopping, by the human operator, the motion of the load based on the observing of step (f).

According to a further aspect of the present invention, a lift system for lifting and lowering a load, the system includes lift hardware, a striker module, a travel limit switch and a visual indicator device. The lift hardware structured to raise and lower the load The visual indicator device is in data communication with the first travel limit switch. The visual indicator device is structured and/or programmed to give a visual indication when the travel limit switch is tripped. The travel limit switch and/or the striker module are structured and/or mechanically connected to move relative to each other in correlation with the lifting and lowering of the load. The travel limit switch and/or the striker module are structured so that the striker module may form a switch tripping connection with the first travel limit switch depending upon the relative positions of the travel limit switch and the striker module.

### BRIEF DESCRIPTION OF THE DRAWINGS

The present invention will be more fully understood and appreciated by reading the following Detailed Description in conjunction with the accompanying drawings, in which:

FIG. 1 is a schematic view of a conventional lift system (including travel limit switches);

FIG. 2 is a schematic view of a first embodiment of a lift system (including travel limit switches and associated indicator lights) according to the present invention;

FIG. 3 is an orthographic side view of a second embodiment of a lift system according to the present invention; and

FIG. 4 is an orthographic opposite (relative to FIG. 3) side view of the second embodiment lift system.

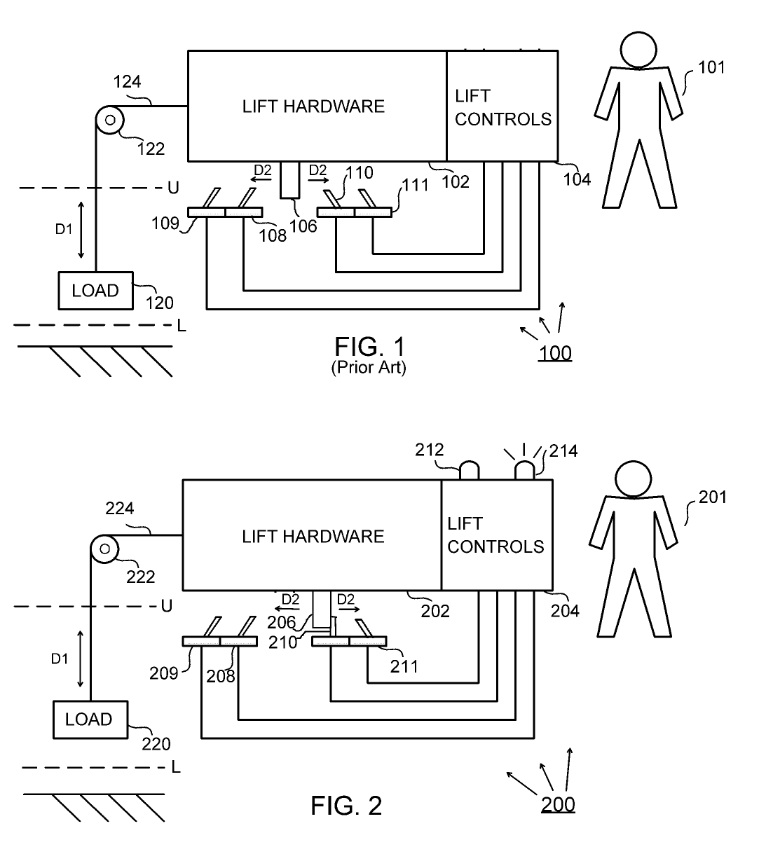

### DETAILED DESCRIPTION OF THE INVENTION

FIG. 2 shows lift system 200 according to the present invention including: lift hardware 202; lift controls 204; striker member 206; primary lower travel limit switch 208; primary lower travel limit switch 209; primary upper travel limit switch 210; secondary upper travel limit switch 211; lower limit indicator light 212; upper limit indicator light 214; load 220; loft blocking sub-system 222; and cable 224.

Primary lower travel limit switch 209 is in data communication with lower limit indicator light 212 through lift controls 204. Primary upper travel limit switch 210 is in data communication with lower limit indicator light 214 through lift controls 204. As shown in FIG. 2, when striker member 206 moves, in a manner correlated with the lifting of load 220 so that it comes into contact with a rotatable member built into switch 210, then the striker member forms a switch tripping connection with switch 210 and thereby trips switch 210. Indicator light 214 receives data effectively communicating that switch 210 has been tripped and, as shown in FIG. 2, turns on.

The turning on of light 214 is a form of visual indication that communicates to the assembler 201 that the upper limit switch 214 has been tripped due to the lifting of the load. Based on his observation of the load 220 position and the visual indication of light 214, assembler 201 determines if the primary upper travel limit switch 214 has been correctly placed. For example, in FIG. 2, the primary upper travel limit switch has not been correctly placed because load 220 is nowhere near upper limit U. This means that the assembler would reposition upper travel limit switches 210, 211 to a revised location further toward the right hand side of FIG. 2 in the direction D2.

On the other hand, if indicator light 214 turned on when load 220 was just reaching upper limit U, then assembler 201 would know that upper travel switches 210 and 211 were correctly placed and would move on to test the tentative placement of the lower travel limit switches 208, 209 by lowering load 220 and observing indicator light 212. When all the switches are correctly placed, the assembler would then connect the switches to the lift controls 204 so that further tripping of the switches would trigger corrective action (of any type now known or to be developed in the future) by the lift controls.

The lights 212, 214 are preferably in the form of LEDs, but any other type of visual indication, now known or to be developed in the future, could be used. For example, a visual indication corresponding to each of the switches 208, 210 could be presented on a display screen such as an LCD display screen. The visual indication(s) of the present invention are preferably located on the lift controls so that assembler 201 can easily see them while simultaneously controlling lifting and/or lowering of the lift. Although lift controls will often be built into a single assembly with the lift hardware, as shown in the example of FIG. 2, this is not required. For example, the lift controls could be located in whole, or in part, at a location remote from the lift hardware.

As an exemplary method of setting up lift system 200 includes the following steps performed by human assembler(s) 201 (not necessarily in the following order): (i) placing the primary limit switches 208, 210 at locations that are estimated to be correct; (ii) connecting primary limit switches 208, 210 into data communication with respective indicator lights 212, 214; (iii) checking the placement of the switches 208, 210 by raising and lowering load 220 to the upper and lower limits U, L while simultaneously watching the indicator lights to determine which load 220 positions will trip the switches 208, 210; (iv) adjusting the location of switches 208, 210 as necessary based on observations at step (iii); and (v) repeating step (iii) and step (iv), as needed, until the primary travel limit switches are in correct locations along direction D2; (vi) ensuring the precisely located switches 208, 210 are in the untripped position; and (vii) putting the precisely located switches into data communication with a corrective action module (for example corrective action control circuitry (not shown) built into the lift controls). After the location of the primary limit switches are set, the secondary limit switches 209, 211 can be placed just a bit outside of the primaries in the D2 direction.

Some other possible variations on system 200 include: (i) connecting both primary limit switches to the same indicator light; (ii) mounting the indicator lights somewhere other than the lift controls; (iii) having moving switch(es) and a stationary striker member; (iv) having additional indicator lights for the secondary travel limit switches; (v) other types of mechanical travel limit switches; (vi) non-mechanical travel limit switches; and/or (vii) wireless data communications (for example, wireless connection between travel limit switches and indicator lights, wireless data communication between travel limit switches and corrective action module).

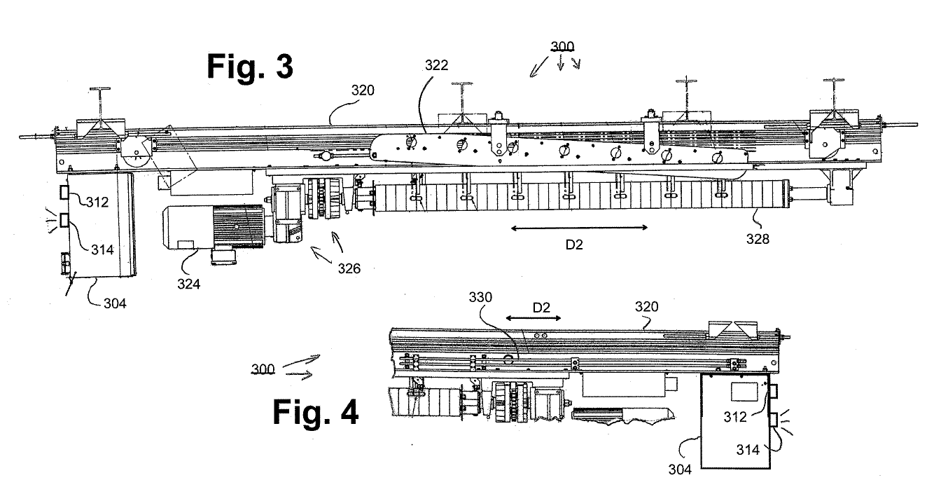

FIGS. 3 and 4 show lift system 300 according to the present invention, system 300 including: lift controls 304; lower limit indicator light 312; upper limit indicator light 314; backbone 320; multiple line head block assembly 322; electric motor 324; gear train assembly 326; multiple line drum 328; and striker/limit switch assembly 330. During lift operations, drum 328 slides along direction D2 relative to the backbone 320, head block assembly 322 and motor 324 in order to maintain a constant (and preferably zero) fleet angle. The hardware for building such a lift system is described in more detail in U.S. published patent application 2006/0163548 published Jul. 27, 2006 and herein incorporated by reference.

In lift system 300, the striker/limit switch assembly 330 includes a striker (not separately designated) that moves back and forth in the D2 direction along with drum 328. During lift setup, and as explained in connection with system 200, the striker actuates the primary limit switches and lights corresponding indicator lights 312, 314 to assist in precisely locating the primary travel limit switches along the D2 direction.

In other preferred embodiments of the present invention, there are three travel limit lights, with each indicator light preferably taking the form of a 24 VDC LED indicators, each respectively wired into the three limit circuits of a winch. Preferably, a blue LED is used to indicate the health of the upper limit circuit (blue=sky=up). Preferably, a green LED is used to indicate the health of the down limit circuit (green=grass=down). Preferably, red LED is used to indicate the health of the overtravel limits circuit (red=emergency). Preferably, when a limit is struck, the corresponding LED is extinguished (rather than vice versa). Preferably, the limits are wired in parallel with the control circuit input, so they are a reliable indicator of the status of that circuit.

When setting the location of the limit switches, the installer runs the winch to the point where a limit switch is struck, then adjusts the position of the limit switch, as explained above, so that it is actuated at the proper position. If the system has been mis-wired (such that the upper limit switch stops downward motion), the installer has no readily available feedback about this condition, leading to significant delays in diagnosis and startup. The visual limit indicators according to the present invention can help reduce or eliminate these potential problems.

### DEFINITIONS

The following definitions are provided to facilitate claim interpretation:

Present invention: means at least some embodiments of the present invention; references to various feature(s) of the “present invention” throughout this document do not mean that all claimed embodiments or methods include the referenced feature(s).

First, second, third, etc. (“ordinals”): Unless otherwise noted, ordinals only serve to distinguish or identify (e.g., various members of a group); the mere use of ordinals implies neither a consecutive numerical limit nor a serial limitation.

Electrically Connected: means either directly electrically connected, or indirectly electrically connected, such that intervening elements are present; in an indirect electrical connection, the intervening elements may include inductors and/or transformers.

Mechanically connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, force fit connections, friction fit connections, connections secured by engagement added by gravitational forces, quick-release connections, pivoting or rotatable connections, slidable mechanical connections, latches and/or magnetic connections).

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output: unless otherwise explicitly specified, these words should not be taken to imply: (i) any particular degree of directness with respect to the relationship between their objects and subjects; and/or (ii) absence of intermediate components, actions and/or things interposed between their objects and subjects.

lift hardware: includes at least a rotatable drum (for example, a cylindrical drum with cable engaging ridges), and a flexible elongated member (for example, a cable or rope) partially wound around the drum so that rotation of the drum can serve to wind or unwind the flexible elongated member and thereby lift or lower a load mechanically connected to the flexible elongated member; lift hardware may or my not include: (i) hardware for driving the drum to rotate (or example, an electrical motor); (ii) a head block sub-system; (iii) a backbone; and/or (iv) other lift related hardware (for example, a brake).

To the extent that the definitions provided above are consistent with ordinary, plain, and accustomed meanings (as generally shown by documents such as dictionaries and/or technical lexicons), the above definitions shall be considered supplemental in nature. To the extent that the definitions provided above are inconsistent with ordinary, plain, and accustomed meanings (as generally shown by documents such as dictionaries and/or technical lexicons), the above definitions shall control. If the definitions provided above are broader than the ordinary, plain, and accustomed meanings in some aspect, then the above definitions shall be considered to broaden the claim accordingly.

To the extent that a patentee may act as its own lexicographer under applicable law, it is hereby further directed that all words appearing in the claims section, except for the above-defined words, shall take on their ordinary, plain, and accustomed meanings (as generally shown by documents such as dictionaries and/or technical lexicons), and shall not be considered to be specially defined in this specification. In the situation where a word or term used in the claims has more than one alternative ordinary, plain and accustomed meaning, the broadest definition that is consistent with technological feasibility and not directly inconsistent with the specification shall control.

Unless otherwise explicitly provided in the claim language, steps in method steps or process claims need only be performed in the same time order as the order the steps are recited in the claim only to the extent that impossibility or extreme feasibility problems dictate that the recited step order (or portion of the recited step order) be used. This broad interpretation with respect to step order is to be used regardless of whether the alternative time ordering(s) of the claimed steps is particularly mentioned or discussed in this document.

What is claimed is:

1. A lift system for lifting and lowering a load, the system comprising:
lift hardware structured to raise and lower the load;
a striker member structured and/or mechanically connected to the lift hardware so that the striker member moves along a path in correlation with the lifting and lowering of the load;
a first travel limit switch in the form of mechanical switch located at least partially on the path and structured so that it will trip when the striker member makes contact with it; and
a visual indicator device in data communication with the first travel limit switch, with the visual indicator device being structured and/or programmed to give a first visual indication when the first travel limit switch is tripped.

2. The system of claim 1 further comprising a lift control module in data communication with the lift hardware, with the lift control module being structured and/or programmed to control operation of the lift hardware.

3. The system of claim 2 wherein:
the lift control module include a user interface section; and
the first visual indication of the visual indicator device is located on the user interface section.

4. The system of claim 2 wherein:
the first travel limit switch can be selectively placed into data communication with the lift control module; and
the lift control module is structured and/or programmed to take corrective action when the first travel limit switch is tripped.

5. The system of claim 1 wherein:
the visual indicator device comprises a first lamp; and
the first visual indication of the visual indicator device comprises lighting of the first lamp.

6. The system of claim 5 wherein the first lamp comprises a light emitting diode.

7. The system of claim 1 wherein:
the visual indicator device comprises a display screen; and
the first visual indication of the visual indicator device is provided on the display screen.

8. The system of claim 1 wherein the first travel limit switch includes a rotatable switch member structured and located to rotate when it is contacted by the striker member.

9. The system of claim 1 wherein;
the lift hardware comprises a drum defining a central axis, drum supporting hardware, and a frame;
the drum and drum supporting hardware are structured and mechanically connected so that the drum translates along the central axis as it rotates around the central axis; and
the striker member is mechanically connected to the drum supporting hardware so that the drum supporting hardware drives the striker member to travel along the path corresponding to the translation of the drum.

10. The system of claim 1 further comprising a second travel limit switch in the form of a mechanical switch located at least partially on the path and structured so that it will trip when the striker member makes contact with it, wherein the visual indicator device in data communication with the second travel limit switch, with the visual indicator device being further structured and/or programmed to give a second visual indication when the second travel limit switch is tripped.

11. The system of claim 10 wherein:
the visual indicator device comprises a second lamp; and
the second visual indication of the visual indicator device comprises lighting of the second lamp.

12. The system of claim 1 wherein the lift hardware is designed for lifting loads typical of theatre applications.

13. A method of setting up a lift system, the method comprising the following steps (not necessarily in the following order except as indicated):
(a) installing a lift system sub-assembly, including lift hardware and a striker member, in or onto a structure;
(b) connecting a load to the lift hardware;
(c) approximately locating a travel limit switch at an approximate position;
(d) putting the travel limit switch in data communication with a visual indication device;
(e) subsequent to steps (d), (c), (b) and (a), moving the load, by the lift hardware, to a location in proximity to a desired travel limit for the load;
(f) during step (e), observing, by a human operator, a visual indication, by the visual indication device, corresponding to the tripping of the travel limit switch; and
(g) during steps (e) and/or (f), stopping, by the human operator, the motion of the load based on the observing of step (f).

14. The method of claim 13 further comprising the following step:
(h) during steps (g), (e) and/or (f) determining, by the human operator, whether the approximate position is the correct position for the travel limit switch based on the load position in the vicinity of the desired travel limit and the observing of step (f).

15. The method of claim 14 further comprising the following steps:
(i) during step (h), determining, by the human operator, that the approximate position of the travel limit switch is not correct based on the load position in the vicinity of the desired travel limit and the observing of step (f); and
(j) subsequent to step (i), repositioning the travel limit switch to a revised approximate position.

16. The method of claim 14 further comprising the following steps:
(k) during step (h), determining, by the human operator, that the approximate position of the travel limit switch is correct based on the load position in the vicinity of the desired travel limit and the observing of step (f); and
(l) subsequent to step (k), putting the travel limit switch into data communication with a lift control module that is structured and/or programmed to take corrective action when the travel limit switch is tripped.

17. A lift system for lifting and lowering a load, the system comprising:
lift hardware structured to raise and lower the load;
a striker module;
a travel limit switch; and
a visual indicator device in data communication with the first travel limit switch, with the visual indicator device being structured and/or programmed to give a visual indication when the travel limit switch is tripped;
wherein:
the travel limit switch and/or the striker module are structured and/or mechanically connected to move relative to each other in correlation with the lifting and lowering of the load; and
the travel limit switch and/or the striker module are structured so that the striker module may form a switch tripping connection with the first travel limit switch depending upon the relative positions of the travel limit switch and the striker module.

18. The system of claim 17 wherein:
the lift hardware comprises a lift frame;
the striker module is structured and/or mechanically connected to the lift hardware so that it moves with respect to the lift frame; and
the travel limit switch is structured and/or mechanically connected to the lift hardware so that it remains stationary with respect to the lift frame.

19. The system of claim 17 wherein:
the lift hardware comprises a lift frame;
the travel limit switch is structured and/or mechanically connected to the lift hardware so that it moves with respect to the lift frame; and
the striker module is structured and/or mechanically connected to the lift hardware so that it remains stationary with respect to the lift frame.

20. The system of claim 17 wherein the travel limit switch is one of the following types: mechanical, electrical, optical, thermal or magnetic.
